(19) United States
(12) Patent Application Publication
(10) Pub. No.: US 2010/0024485 A1
(43) Pub. Date: Feb. 4, 2010

(54) Method and Apparatus for the Purpose of Conserving Energy in the Glass Industry

(76) Inventor: William Stuart Duerk, Defiance, OH (US)

Correspondence Address: William Stuart Duerk, 2001 Baltimore St, Defiance, OH, 43512, US

(21) Appl. No.: 12/512,498

(22) Filed: Jul. 30, 2009

Related U.S. Application Data
(60) Provisional application No. 61/084,958, filed on Jul. 30, 2008.

(51) Int. Cl. C03B 25/00; C03B 29/00; C03B 19/00

(52) U.S. Cl. 65/66; 65/181; 65/348

(57) ABSTRACT

The conservation of energy in the glass industries via the use of heat shields to decrease the amount of energy lost during transportation from the forming process to the annealing process. For maximum effectiveness, the thermal shields are made of materials whose surface has an emissivity of, but not limited too, less than 0.3. They are mounted from, or adjacent to, the means of conveyance of the glass material such that their use will not prohibit the normal production of such glass product. Their installation shall include the means for quick removal or relocation in case of production upsets. The heat shields reflect the radiant energy that is emitted from the high temperature glass back onto itself, and adjacent products, in a manner such as to reduce the loss of energy from such product that may subsequently be necessary for the annealing process.

### PREVIOUS APPLICATION

This application emanates from a previous application; 61/084,958 filed Jul. 30, 2008

### FIELD OF THE INVENTION

This invention relates to a method and apparatus in the Glass industries to conserve energy between the forming and annealing processes. The present invention relates particularly to a method and apparatus utilizing radiant heat shields alongside and/or above the mode of conveyance specifically between the forming and the annealing processes of glass products to conserve energy.

### BACKGROUND OF THE INVENTION

Glass products are widely used to contain and/or protect many things. Glass can be molded into almost any shape imaginable, once heated to a molten state. Much energy is expended to either create glass from raw materials or, to a lesser extent, to heat existing glass up to a liquid state in order to be formed into its final shape. This usually requires temperatures above 2500° F., depending on composition of the batch. Once these products are formed, some of these final products require an additional heating and cooling step, called annealing, to remove the thermal stresses created by variations in cooling rate of the opposing sides. This allows the glass product to sustain higher stress levels prior to product failure.

The glass products move from the forming process in which they are made via a means of conveyance suitable to their respective shape and subsequent process step. Those products requiring an annealing process loose much of their thermal energy during transport to the next process step. U.S. Pat. No. 4,111,676 provides for a method of adapting an existing tempering and bending machine of a tempering line into one that can convey flat glass from a tempering oven to a subsequent quenching zone. Said apparatus utilizes a heat shield on the upper side of the glass sheet to create an even heat transfer rate between the upper and lower portions of the glass sheet during transport to said quenching zone in order to maintain its flatness. This process is located downstream of the annealing process.

U.S. Pat. No. 5,656,052 includes a design for a tempering oven that utilizes vertical heat shields located adjacent to heating elements in order to precisely control the temperature profile across a glass sheet that is subsequently bent. These shields are oriented perpendicular to the glass sheets and are used to direct the radiant energy to specific areas upon the glass sheets. This invention utilizes heat shields within a bending oven to direct radiation from a separate heat source onto glass sheets in order to control the temperature profile of said glass sheets.

U.S. Pat. No. 4,793,849 presents an improved heat shield for the feeding end of a forehearth in order to reduce heat loss from the molten glass, thereby maintaining closer control of the temperature and subsequent viscosity of said molten glass. This invention relates to the conservation of energy whilst the glass is in its molten phase, prior to any product formation.

Some products in continuous production are occasionally kept from loosing too much energy by utilizing burners along the means of conveyance, thus requiring additional energy in the overall manufacturing process. It is towards the reduction of this additional energy, and further annealing energy required within the oven or lehr, that the present invention is directed.

### SUMMARY OF THE INVENTION

An object of the present invention is a method and apparatus for the conservation of energy used in the glass industries, specifically during transport between the forming process and up to and including the entrance of a subsequent annealing process. This is accomplished via the use of radiant heat shields that are located parallel and/or adjacent to one another and mounted on either side of the glass product thereby reducing the amount of energy lost during transport. The shields are mounted either on, or adjacent to, the means of conveyance of said glass products. Said heat shields can be mounted either on, or adjacent to, said annealing oven, or lehr, such that the entire traverse of the glass product is utilized to the extent as not to prohibit normal operations of said means of conveyance. The heat shields are placed such that the glass products are not visually obstructed from the operator during the entire conveyance between the forming process and annealing process. The shields are mounted in such a manner that they are both adjustable, in case of product variation, and quickly and easily removed in case of a production upset.

For further understanding of the present invention, attention should be directed to the brief description of the drawings, to the detailed description of the invention and the claims appended.

### BRIEF DESCRIPTION OF THE DRAWINGS

FIG. 1 is a plan view of a glass product forming machine, conveyors and annealing oven, or lehr, indicating various locations of heat shields, according to the embodiment of the present invention.

FIG. 2 shows several cross sectional views of a conveyor indicated in FIG. 1 that shows various possible ways and shapes of which the heat shields can be arranged about the glass product, according to the embodiment of the present invention.

FIG. 3 shows a cross section of an entrance to an annealing lehr that shows placement of heat shields in relation to said lehr, according to the embodiment of the present invention.

### DESCRIPTION OF THE PREFERRED EMBODIMENT

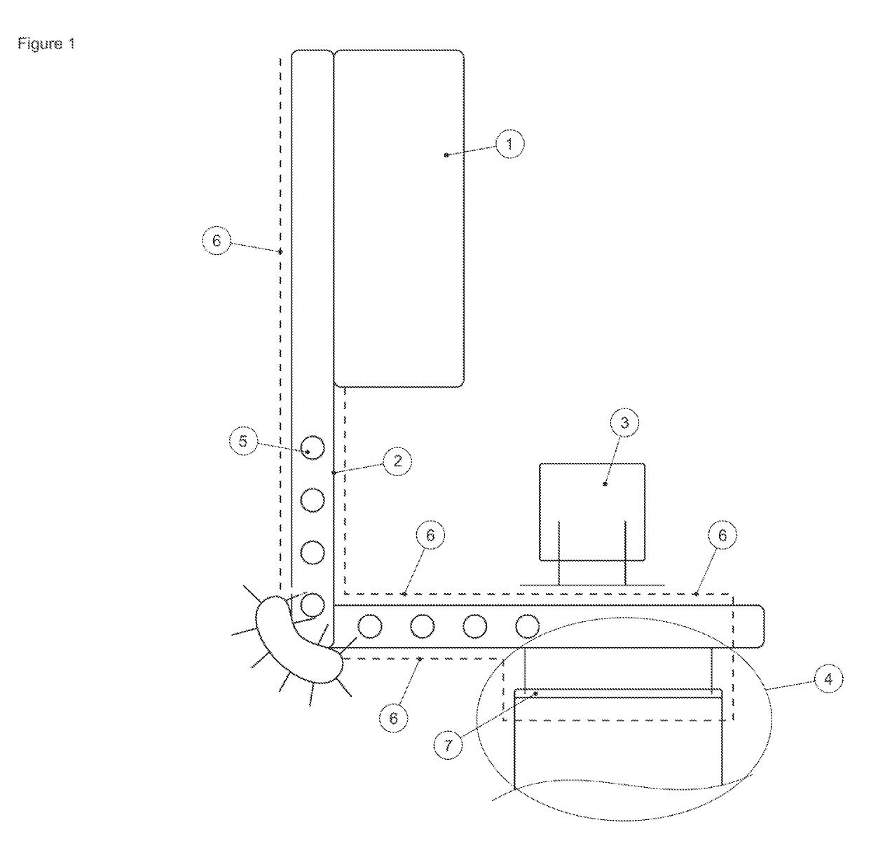

A means of reducing the amount of energy required for annealing products 5 in the glass industry according to the embodiments of FIGS. 1,2 and 3, by means of utilizing heat shields 6 in order to reduce the amount of thermal energy losses while in transit on a means of conveyance 2 from the forming process 1 up to and including the entrance of the annealing oven 4, or lehr 4. The heat shields 6 reflect the majority of the radiant energy that is emitted from the glass products 5 in transit back onto themselves and adjacent products 5, thus reducing the energy lost to the surrounding environment. The amount of energy that is conserved whilst in transit, and in the subsequent annealing process 4, will be a function of the initial temperatures, surface areas, and time in transit between the forming 1 and annealing 4 processes, of the various glass products 5, although several hundred degrees of product 5 temperature loss is common.

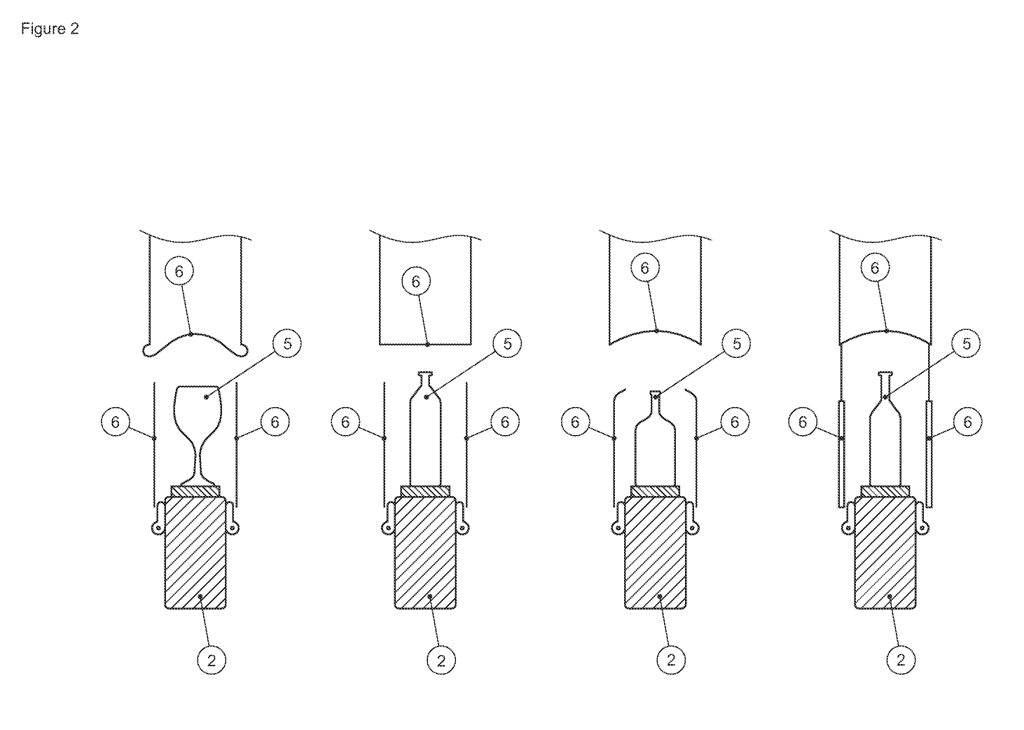

The mounting of the heat shields 6 shall be preferably from the means of conveyance 2. The heat shields 6 may alternatively be mounted external to the means of conveyance 2 from either above, below, or from either side, however preferred. The heat shields 6 shall be made adjustable, when applicable, to account for the various heights and/or widths of glass products 5 which may be produced on the same production line. The shields 6 shall be able to be removed or relocated quickly in the case of a production upset, preferably by a single operator. This can be accomplished via many different means, including but not limited to hinges or mounting brackets. The heat shields 6 shall be mounted in such a manner as not to interfere with the usual operation of the means of conveyance 2, any additional necessary equipment which may be mounted on or adjacent to said conveyance 2, or the glass products 5 located thereon, or in a manner which obstructs the view of the operator(s) who monitors the process from observing any upset of such glass products 5. Various possible arrangements and shapes of these heat shields 6 are disclosed in FIG. 2., but in no way indicates all possibilities.

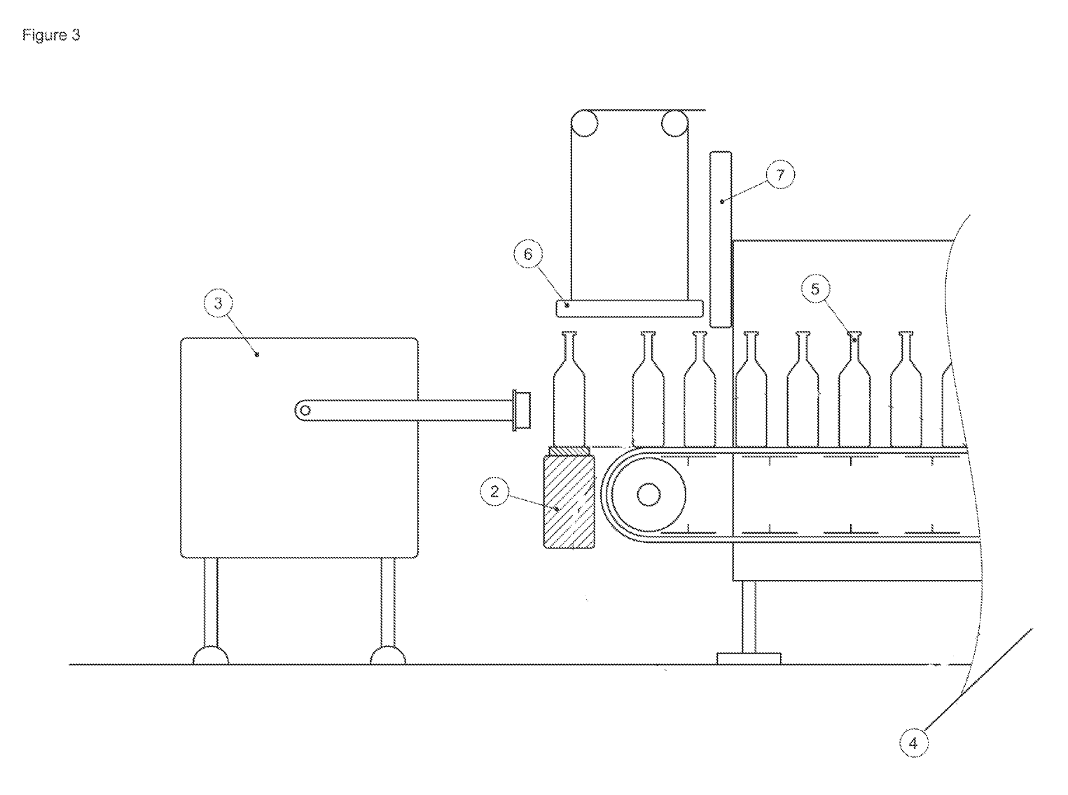

Heat shield(s) 6 for the annealing oven 4, or lehr 4, shall be mounted, likewise, as the aforementioned means of conveyance 2 and one such manner is contemplated in FIG. 3. The heat shield(s) 6 shall span the entire width of the annealing oven 4, or lehr 4, in such a manner as to not interfere with the loading mechanism 3 or the entrance door 7 to the aforementioned oven 4, or lehr 4. They may be either a single shield 6 or several shields 6 in order to cover the entire span of the annealing oven 4, or lehr 4. The shield(s) 6 shall be mounted in such a manner that the vertical distance between the tops of the glass products 5 and the reflective surface of the heat shield(s) 6 can be minimized without interference to the normal operation of the annealing oven 4, or lehr 4, in a uniform manner. This can be accomplished using ropes and pulleys, adjusting screws, or by other means. The use of springs, counterweights, or other means facilitate the adjustment of said heat shield 6 is recommended. The edges of the heat shield(s) 6 located towards the loading mechanism 3 and outer edges shall be bent or curved inward such that the radiant energy from the glass products 5 is redirected back onto the said glass products 5.

The surface of the heat shields 6 shall preferably have a surface emission of, but not limited too, less than 0.3. Common materials that exhibit these low-emissive characteristics include, but are not limited to, polished metals, metallic foils and insulations, silver, gold and low-emission glass and that glass which includes metal oxide-based coatings, to name a few. The heat shield(s) 6 can be made from either a singular material meeting the low-emission requirement, or a plurality thereof.

What is claimed is:

1. An apparatus for the purpose of conserving energy in the Glass industry whilst glass products are in transit between the forming and annealing processes, such apparatus comprising;
a glass forming device which shapes molten glass into its appropriate shape required for the annealing process;
a means of conveyance for moving glass products from the forming process to an annealing process;
a device used to load glass products into an annealing oven or lehr;
a glass annealing oven, or lehr, and;
heat shields.

2. An apparatus according to claim 1 wherein the heat shields are mounted,
either directly on, above, below, or adjacent to, the various means of conveyance and annealing oven or lehr;
on opposing sides and/or adjacent to one another such that their arrangement maximizes the reflectance of radiant energy back onto the glass product source(s);
such that their use in no way prohibits the normal operation of said conveyance, or any additional steps which may be required and performed thereon, whilst in transit to the annealing process;
in a manner which does not totally obstruct the operators view of said glass products whilst in transit in case of production upset;
in a manner that facilitates the quick removal or relocation of such shields.

3. An apparatus according to claim 2 wherein the heat shields used on the entrance of the annealing oven or lehr,
span the entire width of the annealing oven or lehr;
can be vertically adjusted in a uniform manner in order to accommodate various glass product heights which may be produced on said oven or lehr;
have inwardly bent or curved edges to direct radiant heat back onto the glass products;
do not interfere with the normal operation of the loading mechanism, entrance door, or any other devices necessary for their proper operation.

4. An apparatus according to claim 1 and claim 2 wherein the heat shields,
have a surface emissivity of, but not limited too, less than 0.3 for maximum energy conservation.

5. The method of conserving energy used for the annealing process in the Glass industry, the method comprising,
Re-radiation of glass products back onto themselves by surrounding said products with heat shields mounted along the means of conveyance between the forming process up to and including the entrance of an annealing oven, or lehr, in such a manner as to minimize the loss of radiant energy from said glass products whilst in transit to, and subsequent transference into, said annealing oven or lehr, thus reducing the amount of energy input required for said annealing process.
